(19) United States
(12) Patent Application Publication
(10) Pub. No.: US 2008/0080835 A1
(43) Pub. Date: Apr. 3, 2008

(54) Video content recording apparatus with card-slot-specific recording

(76) Inventor: Matthijs C. Hutten, Redwood City, CA (US)

Correspondence Address: BRINKS HOFER GILSON & LIONE/SanDisk, P.O. BOX 10395, CHICAGO, IL, 60610, US

(21) Appl. No.: 11/540,121

(22) Filed: Sep. 29, 2006

(51) Int. Cl. H04N 5/91

(52) U.S. Cl. 386/83

(57) ABSTRACT

A video content recording apparatus with card-slot-specific recording is disclosed. In one embodiment, a video content recording apparatus is provided comprising an input configured to receive video content; a plurality of inputs, each configured to receive a removable memory device; and circuitry operative to select one of the plurality of inputs to record the video content based on information about the video content. In another embodiment, a video content recording apparatus is provided comprising circuitry operative to display a graphical user interface on the display device, the graphical user interface allowing a user to designate one of the plurality of inputs for recording video content comprising specified video content information. The circuitry is further operative to select one of a plurality of inputs to record video content based on information about the video content. In yet another embodiment, a video content recording apparatus is provided comprising circuitry operative to select a second input to record video content onto a second removable memory device after a first removable memory device in a first input is full. Other embodiments are disclosed, and each of the embodiments can be used alone or together in combination.

### BACKGROUND

In the past decade, advances have been made to provide consumers with enhanced control over the timing of video content recording and playback. For example, digital video recorders (“DVRs”) allow consumers to more easily record video content, as compared to using a video cassette recorder (“VCR”), and allow consumers to playback the video content whenever they like—even during the recording of the video content. Because most DVRs use a hard drive to store video content, the stored video content is often “tied” to the display device (e.g., television) connected to the DVR, restricting where the consumer can playback the video content. Devices are available that record video content onto a removable memory card. Once the video content is recorded, the memory card can be removed from the recording device and inserted into a portable playback device, such as a computer, smart phone, or portable media player. This allows consumers to watch video content whenever they want and wherever they want.

### SUMMARY

The present invention is defined by the following claims, and nothing in this section should be taken as a limitation on those claims.

By way of introduction, the embodiments described below provide a video content recording apparatus with card-slot-specific recording. In one embodiment, a video content recording apparatus is provided comprising an input configured to receive video content; a plurality of inputs, each configured to receive a removable memory device; and circuitry operative to select one of the plurality of inputs to record the video content based on information about the video content. In another embodiment, a video content recording apparatus is provided comprising an input configured to receive video content; an output configured to provide video output to a display device; a plurality of inputs, each configured to receive a removable memory device; and circuitry operative to display a graphical user interface on the display device, the graphical user interface allowing a user to designate one of the plurality of inputs for recording video content comprising specified video content information. The circuitry is further operative to select one of the plurality of inputs to record the video content based on information about the video content. In yet another embodiment, a video content recording apparatus is provided comprising circuitry operative to select a second input to record video content onto a second removable memory device after a first removable memory device in a first input is full. Other embodiments are disclosed, and each of the embodiments can be used alone or together in combination.

The embodiments will now be described with reference to the attached drawings.

### BRIEF DESCRIPTION OF THE DRAWINGS

FIG. 1 is an illustration of a system of an embodiment for video content recording.

FIG. 2 is an illustration of an operation of a video content recording system of an embodiment.

FIG. 3 is a block diagram of a video content recording apparatus of an embodiment.

FIG. 4 is an illustration of a video content recording apparatus of an embodiment having a plurality of inputs configured to receive a removable memory device, each of the plurality of inputs being for a different type of removable memory device.

FIG. 5 is an illustration of a video content recording apparatus of an embodiment having a plurality of inputs configured to receive a removable memory device, all of the plurality of inputs being for a same type of removable memory device.

FIG. 6 is an illustration of a video content recording apparatus of an embodiment having a first plurality of inputs for a first type of removable memory device and a second plurality of inputs for a second type of removable memory device.

FIG. 7 is an illustration of a video content recording apparatus of an embodiment having a plurality of inputs configured to receive a removable memory device, each input labeled with a genre type and slot number.

FIG. 8 is a screen display of an embodiment that allows a user to designate a removable-memory-device input for recording video content comprising specified video content information.

FIG. 9 is an illustration of an embodiment in which a removable memory device provides, to a video content recording apparatus, a designation of which removable-memory-device input should be used to record video content comprising specified video content information.

FIG. 10 is an illustration of a screen display of an embodiment that allows a user to designate video content information when scheduling a recording.

FIG. 11 is an illustration of electronic program guide data of an embodiment.

### DETAILED DESCRIPTION OF THE PRESENTLY PREFERRED EMBODIMENTS

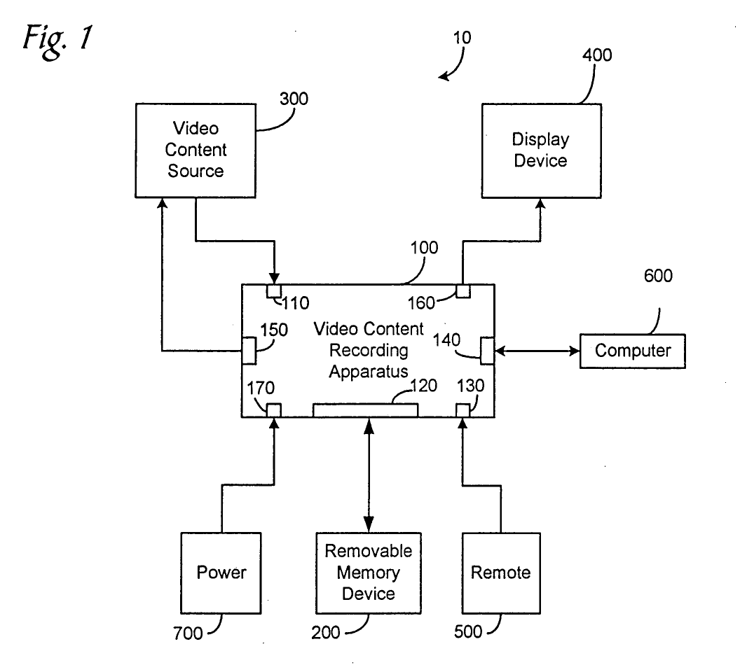

Turning now to the drawings, FIG. 1 is an illustration of a system 10 of an embodiment for recording video content. Video content can take any suitable form. In many situations, video content contains moving images; however, in some situations, video content can contain one or more still images. Examples of video content include, but are not limited to, a cable television broadcast, a satellite television broadcast, a terrestrial (i.e., “over-the-air”) television broadcast, or a video output from a VCR, DVD player, camcorder, camera/video phone, personal or digital video recorder (e.g., TiVo™), game player, or personal computer (e.g., an Internet broadcast). Video content can be in analog or digital form and converted from one form to another.

Video content is most often, but not always, associated with audio content that is played in a synchronized fashion with the video content. To simplify the discussion of these embodiments, audio content will not be treated in as much detail as video content. It should be kept in mind, however, that when an action or element is described in the following description and claims solely in the context of video content, no assumptions should be made regarding whether or not that action or element also relates to audio content. For example, when it is said that video content is recorded and played back, no assumption should be made as to whether or not audio content is also being recorded and played back.

Referring back to FIG. 1, the system 10 comprises a video content recording apparatus 100, a removable memory device 200, a video content source 300, a display device 400, a remote control device 500, a computer 600 and a power supply 700. The video content recording apparatus 100 will be described in more detail below.

A “removable memory device” refers to a storage device that can be placed in/on and removed from the video content recording apparatus 100. A removable memory device 200 can take any suitable form, and it is presently preferred that the removable memory device 200 take the form of a non-volatile, solid-state memory device, such as a flash memory card. Memory cards of a particular type typically conform to a standard size and format and are interchangeable in the sense that they can be inserted and removed from a variety of host devices. Suitable flash memory cards include, but are not limited to, the following memory cards: SD™, SD™(HC), MiniSD™(HC), MMC™, MMCPlus™, MMCmobile™, MicroSD™(HC), Memory Stick™, Memory Stick PRO™, Memory Stick Duo™, and Memory Stick PRO Duo™. A USB memory device can also be used. Any suitable type of memory array can be used in a solid-state memory device, including a write-many or write-once two-dimensional or three-dimensional array, made from any suitable material. While it is presently preferred that the removable memory device 200 be a solid-state memory device, other removable memory devices can be used, such as, but not limited to, an optical disc and a magnetic disk.

A video content source 300 is any device that provides video content. Examples of a video content source include, but are not limited to, a cable tuner box, a satellite tuner box, a digital video broadcasting (DVB) tuner box, a terrestrial antenna, a set-top box, a VCR, a DVD player, a camcorder, a digital camera, a camera/video phone, a personal or digital video recorder (e.g., TiVo™), a game player, or a personal computer. The video content source 300 can provide video content in analog or digital form. A display device 400 can be a monitor or television, for example. In some situations, the video content source 300 is part of the display device 400, such as when the display device 400 is a television with a built-in tuner. The remote control device 500 is typically a wireless handheld user interface device used to communicate user commands to the video content recording apparatus 100. The computer 600 can be any suitable computing device, and the power supply 700 can be AC or a battery or both.

As shown in FIG. 1, the video content recording apparatus 100 comprises a variety of inputs and outputs to place the video content recording apparatus 100 in communication with other components. It should be noted that the video content recording apparatus 100 can contain additional or different inputs and outputs. It should also be noted that even though the term “input” and “output” are used and one-way arrows are sometimes used in the drawings, in some situations, there can be two-way communication between the video content recording apparatus 100 and the component connected via the input/output. Also, any suitable type of input or output can be used, and the terms input and output should be not restricted to the examples set forth in this description. Further, while the inputs and outputs are described herein as “first input,” “first output,” “second input,” etc., the first and second inputs (or outputs), for example, are not necessarily the same type of inputs (or outputs) just because the word “input” (or “output”) is used. For example, one input can be a physical connector, while another input can be an infrared receiver.

The video content recording apparatus 100 comprises a first input 110 configured to receive video content from the video content source 300. Although any suitable input can be used, it is presently preferred that the first input be a composite video input. Composite video combines the three basic elements of a video picture (color, brightness, and synchronization data) into a single combined signal and is commonly used in consumer video equipment. The video content recording apparatus 100 also comprises a second input 120 configured to receive the removable memory device 200. When the removable memory device 200 takes the form of a memory card, the second input 120 can be a slot in the video content recording apparatus 100 that contains an electrical connector that mates with a mating connector on the memory card. The second input 120 can be adapted for any suitable removable memory device (e.g., the second input 120 can be a tray for receiving an optical disc). Although only a single second input 120 is shown in FIG. 1, it should be understood that the video content recording apparatus 100 can contain inputs for a plurality of removable memory devices of the same type or of different types.

The video content recording apparatus 100 further comprises a third input 130 configured to receive user input. As shown in FIG. 1, the third input 130 can be configured to receive a communication from the remote 500. For example, the third input 130 can be an infrared receiver that receives infrared transmissions from the remote 500; however, other inputs can be used (e.g., a physical connector if the remote 500 is wired to the video content recording apparatus 100 with an electrical or optical cable). The third input 130 can also be one or more buttons or other types of user interface elements on the apparatus 100 itself. As yet another alternative, the third input 130 can comprise both user interface elements on the apparatus 100 itself as well as be configured to receive a communication from the remote 500. In other words, the third input 130 can take any form to allow a user to provide input to the apparatus 100 where some or all of the user interface elements (e.g., buttons, switches, etc.) can be on the remote 500 or on the apparatus 100 itself (or any other component). In this way, all of the user interface elements can be on the remote 500, all of the user interface elements can be on the apparatus 100 itself, or there can be a mix of user interface elements on the remote 500 and the apparatus 100 itself.

The video content recording apparatus 100 also comprises a fourth input 140 configured to allow the apparatus 100 to be connected to the computer 600. It is presently preferred that the fourth input 140 be a USB connector. Although not shown, the video content recording apparatus 100 can comprise inputs (e.g., left and right channels) for audio content.

The video content recording apparatus 100 also has a number of outputs, such as the first output 150 that is configured to provide control information to the video content source 300. The first output 150 is preferably an infrared emitter that communicates control information to the video content source 300 via an infrared transmission, although other wireless technologies can be used. As an alternative to using wireless technology, the first output 150 can be physically connected to the video content source 300, e.g., via an electrical or optical cable. The second output 160 is configured to provide video content and other display output (e.g., a graphical user interface) to the display device 400 and is preferably a composite video output and, optionally, an HDTV output. The power input 170 receives power from the power supply 700. Although not shown, the video content recording apparatus 100 can comprise outputs (e.g., left and right channels) for audio content.

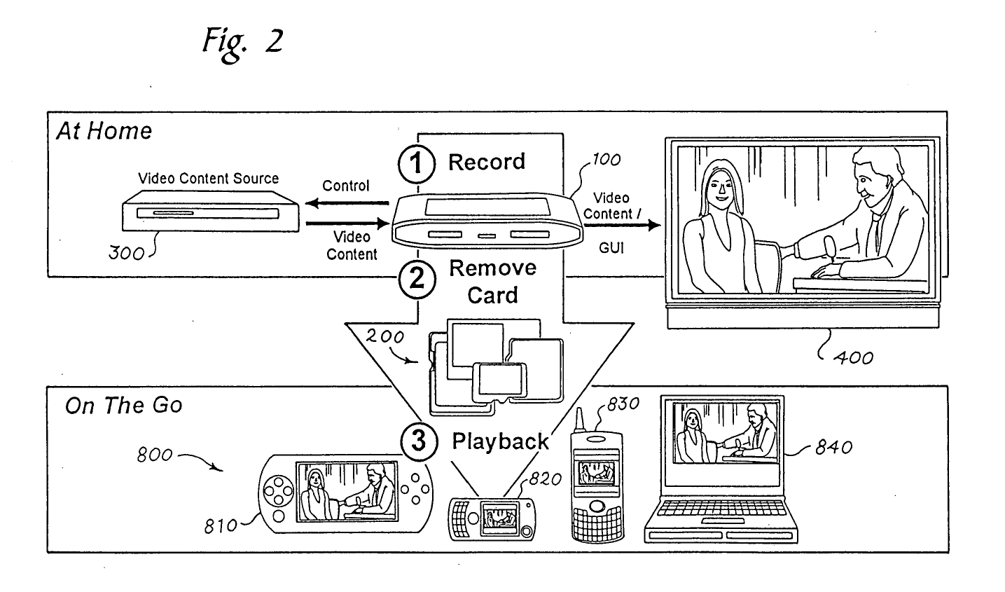

FIG. 2 illustrates the operation of one embodiment of the video content recording system 10. In this embodiment, the video content recording apparatus 100 takes the form of a “video memory card recorder,” and the removable memory device 200 takes the form of a flash memory card. (As shown in FIG. 2, the video memory card recorder has a plurality of card slots to support different types of memory cards.) The video content recording apparatus 100 has similar recording and playback functionality as a video cassette recorder (“VCR”) but uses flash memory cards instead of VCR tapes.

As shown in FIG. 2, the first step is for the video content recording apparatus 100 to record video content from the video content source 300 directly onto the removable memory device 200. (In an alternate embodiment, the video recording apparatus 100 contains an additional storage device (or an existing storage device that is otherwise used for a different purpose) that allows video content to be stored (temporarily, as in a cache, or otherwise) before recording it onto the removable memory device.) If the recording is a scheduled recording, the video content recording apparatus 100 sends control information via the first output 150, e.g., an IR emitter, (see FIG. 1) to turn on the video content source 300 and select a channel. As with a VCR or a DVR, the scheduled recording can be based on channel, date, and start/stop times, including daily and weekly repeats. The video content recording apparatus 100 can display a graphical user interface (“GUI”) on the display device 400 to provide an easy way for a user to schedule a recording, as well as to playback video content and change settings. During the recording of the video content onto the removable memory device 200, the video content recording apparatus 100 can also display the video content on the display device, either in real-time or otherwise, such as when the user “pauses” and then resumes watching a live broadcast. The video content recording apparatus 100 can also have additional functionality, such as, but not limited to, playing back and archiving digital photos, playing back audio files, and, as described in more detail below, acting as a card reader for a computer.

After the recording, the user removes the removable memory device 200 from the video content recording apparatus 100 and inserts it into a playback device 800 for playback. A playback device can be any video-enabled device, such as but not limited to, a handheld game console 810 (e.g., the Sony PSP™ or the Nintendo DS™), a mobile phone 820, a smart phone 830, a PC/notebook computer 840, a portable media player, such as a SanDisk Sansa™ e200 Series MP3 player, a handheld computer or other video-enabled device (including, but not limited to, a Windows CE device), a set-top box, or a display device (e.g., a television) with playback functionality. A playback device can also be the same (or different) video content recording apparatus 100 that recorded the video content onto the removable memory device 200. Accordingly, as described in more detail below, video content can be recorded on the removable memory device 200 in a format that is both suitable for small screen sizes of portable playback devices as well as full-screen sizes of display devices.

As can be seen from the examples noted above, a playback device can perform functions in addition to playing back video content stored on the removable memory device 200. For example, the playback device can also play games, make telephone calls, receive email, or even record video content. Also, while it would be especially convenient for the playback device to contain an input for the removable memory device 200 (e.g., a memory card slot), so the user can just “plug in” the removable memory device 200 into the playback device, some playback devices may not contain such an input, such as some existing portable media players, or may not have an input for the type of memory device (e.g., memory card) used by the video content recording apparatus 100. In these situations, the user can transfer the video content from the removable memory device 200 first to an intermediary device, such as a personal computer 840, and then from the intermediary device to the ultimate playback device (e.g., using software on the intermediary device).

As can be seen from the illustration in FIG. 2, the video content recording apparatus 100 allows a user to store and watch video content when he wants and wherever he wants (e.g., on the road, during a commute, at a friend's house, etc.). By using the removable memory device 200 as a transport medium for video content, the video content recording apparatus 100 frees the user from the static viewing environment of his home. Also, unlike some existing DVRs that achieve video content portability by requiring a user to transfer the video content from the DVR to a personal computer, the video content recording apparatus 100 records the video content directly onto the removable media device 200 without requiring a personal computer. Using a removable media device 200 to provide video content to a playback device is also faster and less expensive than subscribing to pricey wireless video services for mobile phones and avoids the uncertainty of whether a wireless connection will be present while a user is roaming. Further, since solid-state memory devices, such as flash cards, can store video content more reliably and for a longer time than videocassette tapes, the video content recording apparatus 100 also provides the advantage of being able to archive precious video content on a more durable medium.

Returning to the drawings, FIG. 3 is a block diagram of the some of the components of the video content recording apparatus 100 of an embodiment. It should be noted that the video content recording apparatus 100 can contain additional or different components than the ones shown in FIG. 3. Also, it is presently preferred that the various inputs, outputs, and components be carried by a housing (an input or output protruding from the housing is still “carried by” the housing). In an alternate embodiment, one or more of the various inputs, outputs, and components are distributed among two or more housings.

As shown in FIG. 3, in addition to the inputs and outputs shown in FIG. 1, the video content recording apparatus 100 comprises a processor 180, embedded memory 185 (e.g., EEPROM or NAND memory), a video encoder 190, a video decoder 193, and LEDs 195. The LEDs can contain a power LED to indicate that the apparatus 100 is on/off, a removable memory device LED to indicate that a removable memory device is recognized/present and ready for transmission, a transmission LED that blinks when data is being transferred, and a recording/warning LED that is on during recording and blinks when there is not enough storage space on the removable memory device or when no removable memory device is present when recording is requested. In one embodiment, an LED is used next to the second input 120 to both indicate the presence of the memory device 200 (e.g., when the LED is continuously on) and to indicate data transfer (e.g., when the LED is blinking).

With reference now to both FIGS. 1 and 3, in operation, based on a recording request, the processor 180 sends control information via the first output 150 to the video content source 300 to turn on the video content source 300 and select a channel. The video content provided by the video content source 300 is sent to the video encoder 190. In this embodiment, the video content is outputted as an analog signal from the video content source 300, and the video encoder 190 converts the analog signal to a digital signal and provides the digital signal to the processor 180. (The video decoder 193 is used for the reverse operation—to convert the digital signal provided by the processor 180 to an analog signal used by the display device 400.) The processor 180 processes the digital signal and records it (preferably, in a compressed format) on the removable memory device 200. Because playback devices vary in video/audio codec support, file format support, screen resolution/orientation, frame rate, bit rate, video processing, card format support, and folder name/structure, it is preferred that the video content recording apparatus 100 know these video content recording parameters upfront in order to create the appropriate video content file and record it in such a way on the removable memory device 200 to make the video content compatible with a target playback device. As used herein, the term “video content recording parameter” refers to a parameter used in recording video content. Examples of a video content recording parameter include, but are not limited to, a video codec parameter, an audio codec parameter, a file format parameter, a file wrapper parameter, frame rate (e.g., frames per second), video bit rate, audio bit rate, audio bit rate variation, a video processing parameter, screen resolution, screen orientation, card format, folder structure, and folder name.

In this embodiment, video content recording parameters (and values for those parameters) for a plurality of playback devices are stored in a database in the firmware stored in the embedded memory 185. In operation, a user selects a target playback device (such as a mobile phone or a handheld game device) using the remote control device 500 and a graphical user interface displayed on the display device 400. After the user makes a selection, the processor 180 selects the corresponding video content recording parameter (and associated values) for that playback device from the database stored in the firmware. The processor 180 then processes and records the video content in the removable media device 200 in accordance with the values of those parameters. Additional information about the use of video content recording parameters and mechanisms for updating video content recording parameters can be found in “Video Content Recording Apparatus with Syntax for Video Content Recording Parameters,” U.S. patent application Ser. No. 11/514,651, filed Sep. 1, 2006, and “Method for Using a Video Content Recording Apparatus with Syntax for Video Content Recording Parameters,” U.S. patent application Ser. No. 11/514,471, filed Sep. 1, 2006, both of which are assigned to the assignee of the present invention and are hereby incorporated by reference.

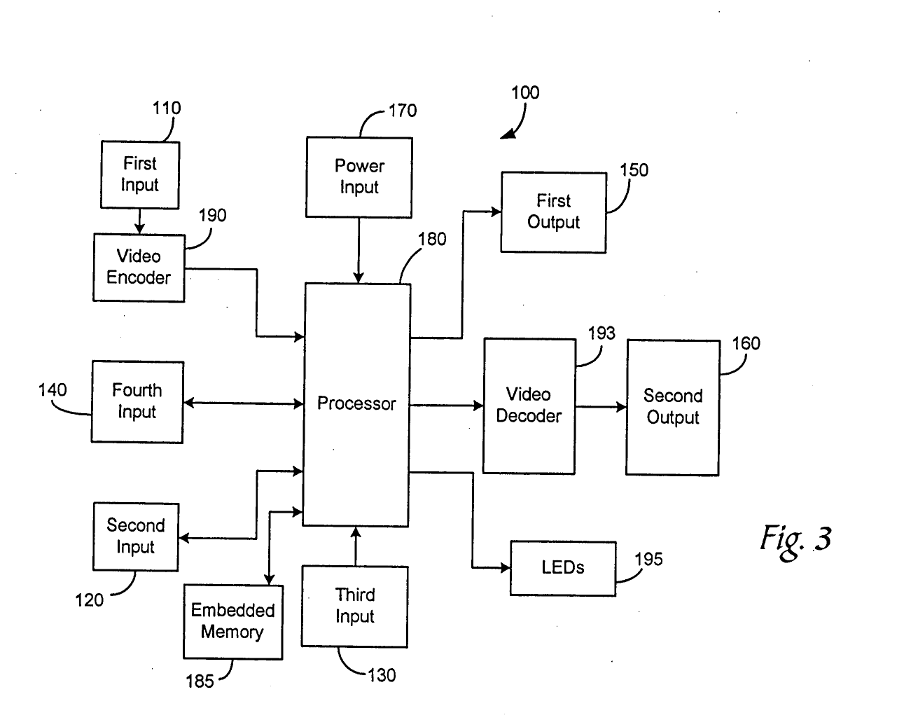

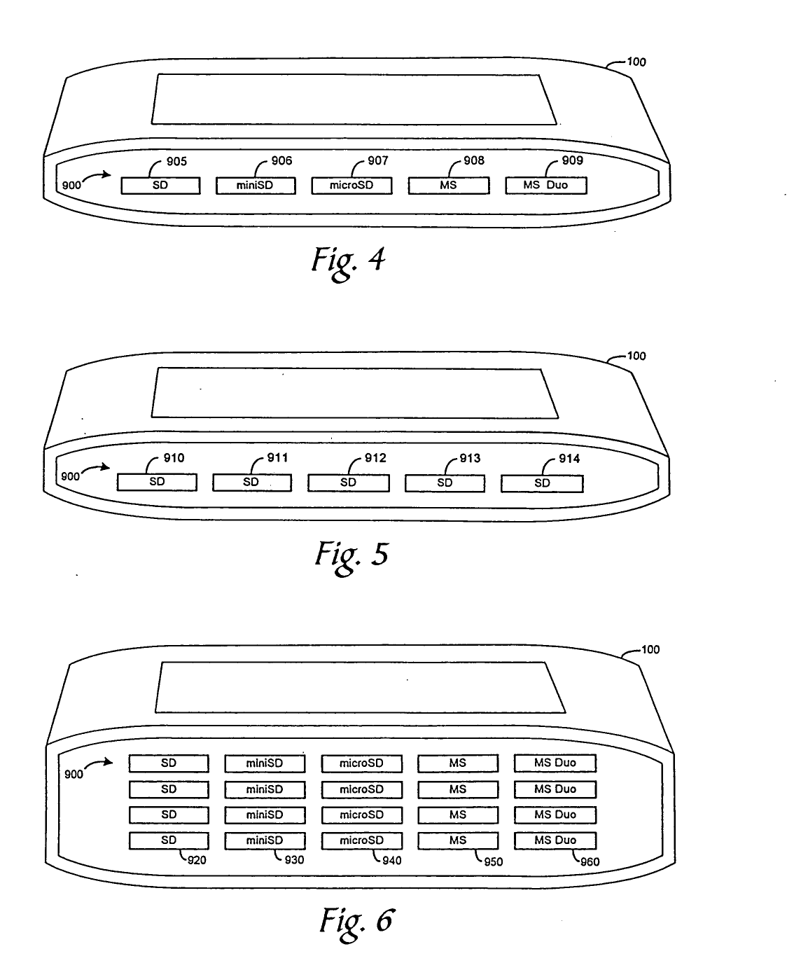

As mentioned above, while the video content recording apparatus 100 can have a single input for a single type of removable memory device, the video content recording apparatus 100 can have a plurality of inputs for a plurality of removable memory devices of the same type or of different types. For example, the video content recording apparatus 100 shown in FIG. 4 has a plurality of inputs 900 configured to receive a removable memory device, where each of the plurality of inputs 905-909 is for a different type of removable memory device. In this example, the plurality of inputs 905-909 are for an SD™ memory card, a MiniSD™(HC) memory card, a MicroSD™(HC) memory card, a Memory Stick™ memory card, and a Memory Stick Duo™ memory card, respectively. As another example, all of the inputs 910-914 of the plurality of inputs 900 in the video content recording apparatus 100 shown in FIG. 5 are for the same type of removable memory device (here an SD™ memory card). As yet another example, the plurality of inputs 900 in the video content recording apparatus 100 in FIG. 6 are organized in several sets of inputs 920, 930, 940, 950, 960. Each set of inputs 920, 930, 940, 950, 960 is for a different type of removable memory device and comprises a plurality of inputs for that memory type. In this example, the sets of inputs 920, 930, 940, 950, 960 are for a plurality of SD™ memory cards, MiniSD™(HC) memory cards, MicroSD™(HC) memory cards, Memory Stick™ memory cards, and Memory Stick Duo™ memory cards, respectively. It should be noted that in this and other illustrations herein, the types of removable memory devices mentioned are merely for illustrative purposes and are not to be read into the following claims. Also, for simplicity, the drawings show each of the inputs as being the same size while, in practice, they may be different sizes.

When two or more removable memory devices are connected to the video content recording apparatus 100, the video content recording apparatus 100 can have a button next to each of the inputs, and a user can press one of the buttons to manually select which of the inputs are to be used for recording. As another example, the user can manually select the input, along with the date, channel, and start/end times of a desired recording, in a scheduled recording setting.

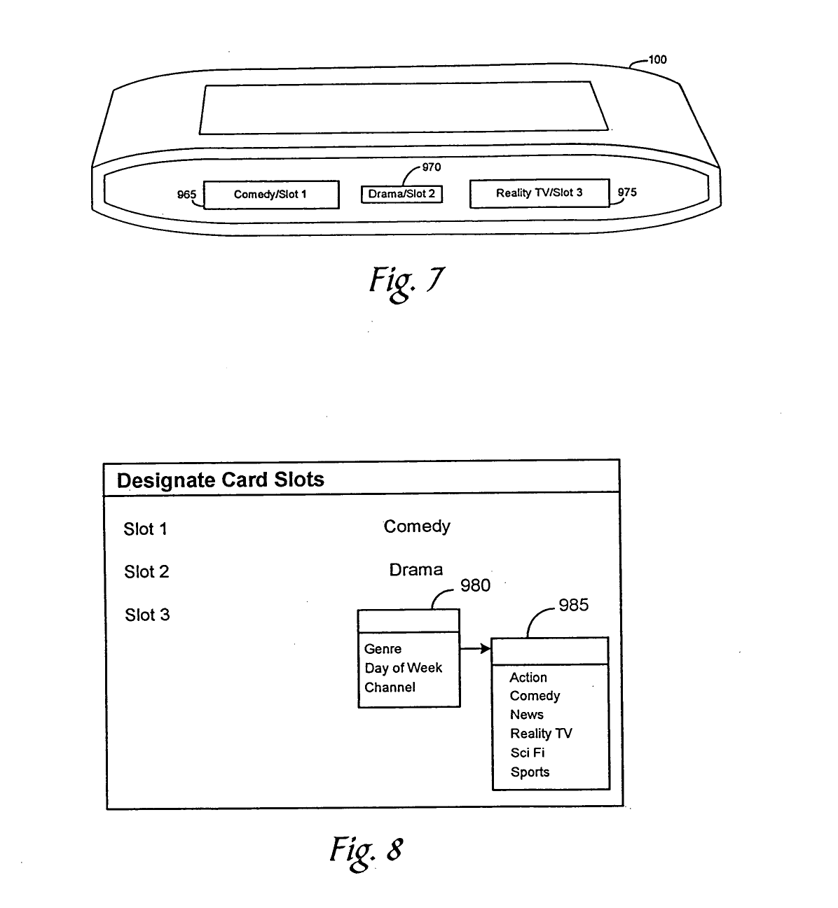

Instead of the user manually selecting one of the removable-memory-device inputs, circuitry in the video content recording apparatus 100 (e.g., the processor 180 executing computer-readable program code stored in the embedded memory 185) can select one of the plurality of inputs to record video content based on information about the video content. “Information about the video content” can include, but is not limited to, one or more of the following: broadcast date, channel number, channel name, start time, end time, title, synopsis, actor, director, year of production, genre, parental control information, and duration. In operation, one or more of the removable-memory-device inputs can be designated for recording video content comprising specified video content information. For instance, with reference to FIG. 7, a video content recording apparatus 100 can have, for example, three memory card slots 965, 970, 975 designated by the manufacturer as recording Comedy, Drama, and Reality TV, respectively, as labeled as such on the video content recording apparatus 100.

Instead of the manufacturer making the designation, a user of the video content recording apparatus 100 can designate which slots should be used for certain types of recordings. For example, the video content recording apparatus 100 can display a graphical user interface on the display device 400 to allow a user to designate one of the plurality of inputs for recording video content comprising specified video content information. With reference to the exemplary display screen shown in FIG. 8, the user can designate what type of programming should be recorded with each memory slot. In the example shown in FIG. 8, the user designates Slot 1 for Comedy and Slot 2 for drama. (The labels on the inputs on the video content recording apparatus 100 can assist the user in identifying the slot number.) As shown in FIG. 8, the user can be provided with a first drop-down menu 980 that allows the user to choose a category of information about the video content (e.g., genre, day of week, channel, etc.) and a second drop-down menu 985 that allows the user to choose a specific sub-category of information (e.g., in the genre category, Action, Comedy, News, Reality TV, SciFi, Sports, etc.).

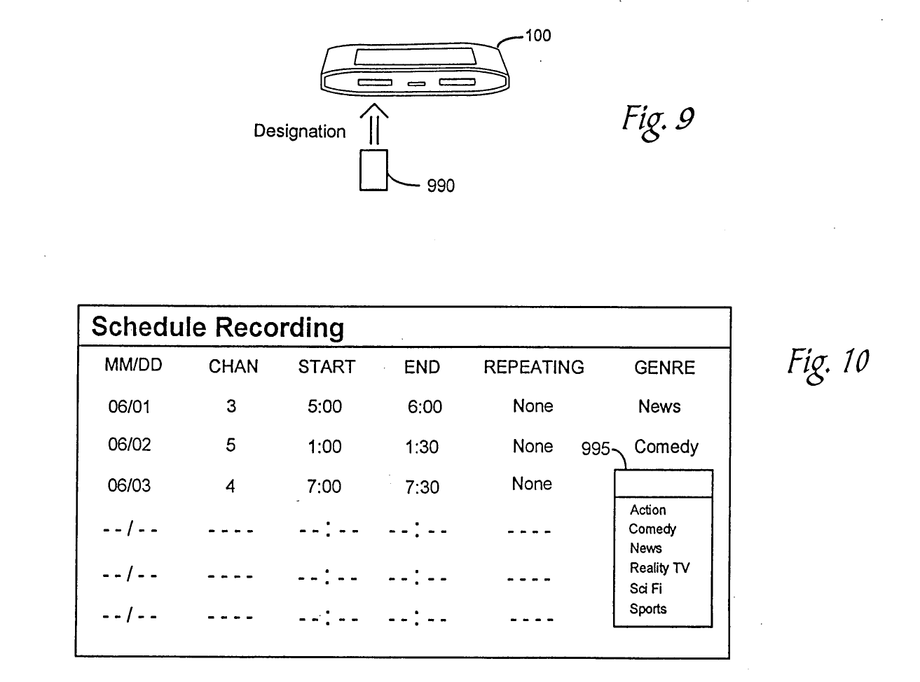

Instead of a manufacturer or a user designating which inputs should be used for various recordings, the designation can be received by the video content recording apparatus 100 from a removable memory device 990 (see FIG. 9). The removable memory device 990 can store a designation that video content comprising specified video content information (e.g., comedies, video content broadcast on Tuesdays, etc.) should be stored on that removable memory device 990. When the removable memory device 990 is inserted into an input of the video content recording apparatus 100, the video content recording apparatus 100 recognizes the designation and selects that input when video content is to be recorded that comprise the specified video content information. In this way, instead of having dedicated removable-memory-device inputs, the user has a dedicated removable memory device that records the same type of programming irrespective of what input is used. The designation can be prerecorded on the removable memory device 990 by the manufacturer of the removable memory device 990 or can be placed on the removable memory device 990 by the user (e.g., via the video content recording apparatus 100 or another device).

Information about the video content can be provided to the video content recording apparatus 100 in any suitable manner. For example, with reference to FIG. 10, the video content recording apparatus 100 can provide a graphical user interface that allows a user to manually designate information about video content when the user is scheduling a recording. In the example shown in FIG. 10, the used is provided with a drop-down menu 995 to help facilitate the entry of the information about the video content. The video content recording apparatus 100 uses this information, along with the above-described designation, to select a removable-memory-device input to use for the recording.

If the user does not know what information to enter, the user can consult a program schedule in a print or electronic TV guide (e.g., in the newspaper, on a website, or in a guide channel). Alternatively, the information about the video content can be specified in electronic program guide data. An electronic program guide (or “EPG”) is a user interface displayed by the video content recording apparatus 100 that provides information about current and/or upcoming video content to allow a user to select a desired recording. Electronic program guide data broadly refers to any information about video content that can be used to facilitate user selection of a desired recording. EPG data includes, but is not limited to, broadcast date, channel number, channel name, start/end times, as well as descriptive information about video content, such as, but not limited to, title, synopsis, actors, directors, year of production, genre, parental control information, and duration.

Instead of using an electronic program guide displayed by the video content recording apparatus 100, information about the video content can also be provided in a scheduled recording file provided by an external electronic program guide (i.e., one provided by a web site and not by the apparatus 100 itself). A “scheduled recording file” is a file that contains information that instructs the video content recording apparatus 100 to record selected video content specified in the file. A “scheduled recording file” can contain, for example, the date, channel, and start/end times of the selected video content, as well as descriptive and other information, such as program name and synopsis, that can later be viewed by the user using the video content recording apparatus 100.

Additional information about electronic program guides, scheduled recording files, and how electronic program guide data can be provided to a video content recording apparatus can be found in “Video Content Recording Apparatus with Electronic Program Guide Functionality,” U.S. patent application Ser. No. ______ (attorney docket no. 10519-154), filed herewith, and “Method for Using a Video Content Recording Apparatus with Electronic Program Guide Functionality,” U.S. patent application Ser. No. ______ (attorney docket no. 10519-166), filed herewith, both of which are assigned to the assignee of the present invention and are hereby incorporated by reference.

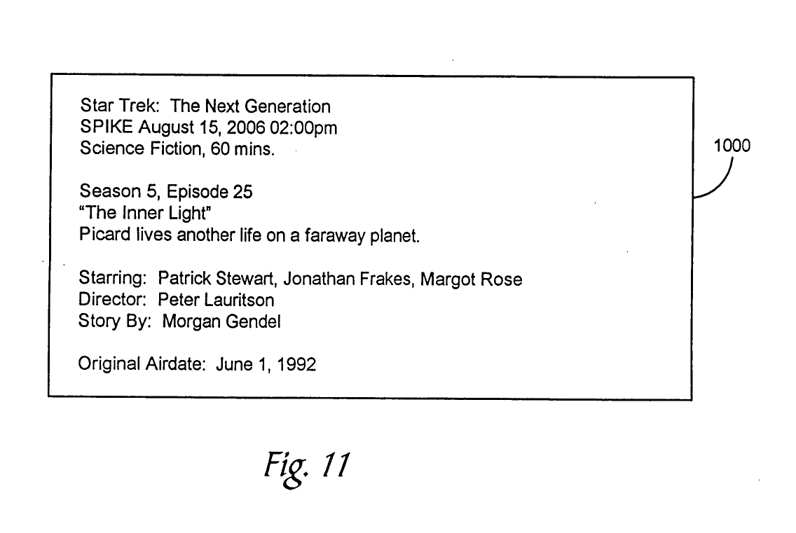

Irrespective of how the electronic program guide data gets to the video content recording apparatus 100, the electronic program guide data can contain information about video content that the apparatus 100 can use to select a removable-memory-device input for recording. For example, FIG. 11 is an illustration of electronic program guide data for an exemplary video content. The electronic program guide data indicates show title, channel name, broadcast date and time, genre, duration, season and episode numbers, episode title, synopsis, actors, director, writer, and original airdate. Here, the genre of the show is SciFi. Accordingly, if one of the removable-memory-device inputs in the apparatus 100 is designated for SciFi programming, the video content described by the electronic program guide data in FIG. 11 would be recorded using that input.

Selecting which removable-memory-device input to use based on information about the video content allows a user to better manage his memory card resources by creating “theme cards.” For example, suppose a user wants to use the video content recording apparatus 100 to record children's programming for his kids to watch on a portable game player and also to record sitcoms that the user can watch on his PDA during morning commutes. By using information about the video content to select an input, all of the video content for the user can be recorded on one card (e.g., in Slot 1), and all of the video content for the user's kids can be recorded on another card (e.g., in Slot 2). In this way, all of the user's video content would be on one card, while all of the user's kids video content would be on another card. This allows the user to “grab and go”—eliminating the need to take multiple removable memory devices in order to find the one program the user wants to watch. This also provides the user with the ability to record on multiple memory devices of the same type without having to swap devices.

It should be noted that many alternatives can be used with these embodiments. For example, circuitry in the video content recording apparatus 100 can select a second input to record video content onto a second removable memory device after a first removable memory device in a first input is full. In this way, the circuitry uses the additional removable-memory-device inputs for extra storage so that when a memory device in a first input is full, the recording will continue in a memory device in another input that contains an available (non-full) memory device (e.g., the physically-next input or another input). Either the user or the manufacturer can designate an order in which the inputs should be used in the event that the removable memory device in one of the inputs becomes full. As another example, several types of selection criteria can be used in combination (e.g., record Reality TV shows in Slot 1, but, if the memory card in Slot 1 is full, record Reality TV shows in Slot 2 instead). Further, while information about video content in the above examples was used to select only one of the plurality of removable-memory-device inputs, in an alternate embodiment, two or more removable-memory-device inputs can be selected (e.g., record Reality TV shows on Slots 1 and 2).

Other alternatives and embodiments can be used with the embodiments described herein. For example, a “recording profile” can be stored on a removable memory device that informs a video content recording apparatus of the video content recording parameters that are to be used with that removable memory device. In operation, when the removable memory device is inserted into the video content recording apparatus, the processor could recognize the recording profile by its file extension and then use the video content recording parameters specified in that file to record video content on that memory device. In this way, a user can insert a memory device into his or another's video content recording apparatus, and the apparatus would know how to record the video content consistent with the user's playback device without requiring any further action by the user. This is especially advantageous when a single video content recording apparatus is used by multiple users, such as in a multi-user household with different users having different playback devices. The video content recording apparatus would automatically record video content for a particular playback device without a user having to manually select a target playback device. More generally, the video content recording apparatus can be configured to (1) always let the recording profile override previous settings, (2) never let the recording profile override previous settings, or (3) let the recording profile override previous settings after confirmation by the user. In the event that the recording profile is used, the video content recording apparatus can be configured to return to its previous video content recording parameters after the removable memory device is removed from the apparatus.

Finally, in the above embodiment, a processor and firmware were used to perform various functionality. Recognizing that there are alternatives to such an arrangement, the term “circuitry” is used as a more general descriptor for the one or more components that can be used to perform the operations discussed herein. For example, as above, “circuitry” can take the form of a processor executing computer-readable program code stored in a computer-readable medium (e.g., here, firmware stored in embedded memory). As noted above, the embedded memory can take the form of EEPROM or NAND memory, although other memory can be used. Also, computer-readable media other than embedded memory (such as, but not limited to, a hard drive, a removable memory device, etc.) can be used to store computer-readable program code. Accordingly, all or part of the computer-readable program code referred to herein as firmware can be software routines stored in embedded memory or in a storage device other than embedded memory. “Circuitry” can take other suitable forms, such as an application specific integrated circuit (ASIC), a programmable logic controller, an embedded microcontroller, and a single-board computer. Accordingly, the term “circuitry” should not be limited to any particular type of implementation, described herein or otherwise. Further, “circuitry” should not be limited to the functions described herein. For example, when circuitry takes the form of a processor executing firmware, as above, it should be understood that the processor can perform functions in addition to the ones described above.

It is intended that the foregoing detailed description be understood as an illustration of selected forms that the invention can take and not as a definition of the invention. It is only the following claims, including all equivalents, that are intended to define the scope of this invention. Finally, it should be noted that any aspect of any of the preferred embodiments described herein can be used alone or in combination with one another.

What is claimed is:

1. A video content recording apparatus comprising:
an input configured to receive video content;
a plurality of inputs, each configured to receive a removable memory device; and
circuitry operative to select one of the plurality of inputs to record the video content based on information about the video content.

2. The video content recording apparatus of claim 1, wherein at least one of the plurality of inputs is designated for recording video content comprising specified video content information.

3. The video content recording apparatus of claim 2, wherein the designation is received from a user.

4. The video content recording apparatus of claim 2, wherein the designation is received from a removable memory device.

5. The video content recording apparatus of claim 1, wherein the information about the video content is specified in a scheduled recording setting.

6. The video content recording apparatus of claim 1, wherein the information about the video content is specified by a user.

7. The video content recording apparatus of claim 1, wherein the information about the video content is specified in electronic program guide data.

8. The video content recording apparatus of claim 1, wherein the information about the video content comprises one or more of the following: broadcast date, channel number, channel name, start time, end time, title, synopsis, actor, director, year of production, genre, parental control information, and duration.

9. The video content recording apparatus of claim 1, wherein each of the plurality of inputs is for a different type of removable memory device.

10. The video content recording apparatus of claim 1, wherein all of the plurality of inputs are for a same type of removable memory device.

11. The video content recording apparatus of claim 1, wherein the plurality of inputs comprises a first plurality of inputs for a first type of removable memory device and a second plurality of inputs for a second type of removable memory device.

12. The video content recording apparatus of claim 1, wherein the circuitry comprises a processor.

13. A video content recording apparatus comprising:
an input configured to receive video content;
an output configured to provide video output to a display device;
a plurality of inputs, each configured to receive a removable memory device; and
circuitry operative to:
display a graphical user interface on the display device, the graphical user interface allowing a user to designate one of the plurality of inputs for recording video content comprising specified video content information; and
select one of the plurality of inputs to record the video content based on information about the video content.

14. The video content recording apparatus of claim 13, wherein the information about the video content is specified in a scheduled recording setting.

15. The video content recording apparatus of claim 13, wherein the information about the video content is specified by a user.

16. The video content recording apparatus of claim 13, wherein the information about the video content is specified in electronic program guide data.

17. The video content recording apparatus of claim 13, wherein the information about the video content comprises one or more of the following: broadcast date, channel number, channel name, start time, end time, title, synopsis, actor, director, year of production, genre, parental control information, and duration.

18. The video content recording apparatus of claim 13, wherein each of the plurality of inputs is for a different type of removable memory device.

19. The video content recording apparatus of claim 13, wherein all of the plurality of inputs are for a same type of removable memory device.

20. The video content recording apparatus of claim 13, wherein the plurality of inputs comprises a first plurality of inputs for a first type of removable memory device and a second plurality of inputs for a second type of removable memory device.

21. The video content recording apparatus of claim 13, wherein the circuitry comprises a processor.

22. A video content recording apparatus comprising:
an input configured to receive video content;
first and second inputs, each configured to receive a removable memory device; and
circuitry operative to select the second input to record video content onto a second removable memory device after a first removable memory device in the first input is full.

23. The video content recording apparatus of claim 22, wherein the circuitry comprises a processor.
